(19) United States
(12) Patent Application Publication
(10) Pub. No.: US 2004/0098337 A1
(43) Pub. Date: May 20, 2004

(54) Systems and methods of linking multiple entities to multiple accounts

(76) Inventors: Jerome E. Gudgeon, Redhill (GB); Andrew P. Kilsby, Warlingham (GB); Christopher D. Jones, Guildford (GB)

Correspondence Address: Stephen T. Scherrer, McDermott, Will & Emery, 227 West Monroe, Chicago, IL, 60606-5096, US

(21) Appl. No.: 10/609,978

(22) Filed: Jun. 30, 2003

(30) Foreign Application Priority Data
Oct. 31, 2002 (GB) 0225401.9

(51) Int. Cl. G06F 17/60

(52) U.S. Cl. 705/42; 705/37; 705/36

(57) ABSTRACT

A customer database is provided that enables entities, such as individuals and/or organizations to be represented and linked to multiple financial accounts of different types and linked to each other. Associated with these links are “permissions” that enable or disable actions that can be performed on particular accounts by the accessing entity. Multiple entities can be linked to multiple accounts to support both retail and advisor-based relationships simultaneously. Additionally, details such as addresses, telephone numbers, and the like are linked to entities and not to individual accounts, so that changes made to the details are made only once and automatically reflected in the linked accounts.

### TECHNICAL FIELD

Systems and methods are provided for linking multiple entities to multiple accounts. Specifically, a customer database enables entities, such as individuals and/or organizations to be represented and linked to multiple accounts of different types and linked to each other. Associated with these links are “permissions” that enable or disable actions that can be performed on particular accounts by the accessing entity. Multiple entities can be linked to multiple accounts to support both retail and advisor-based relationships simultaneously. Additionally, details such as addresses, telephone numbers, and the like are linked to entities and not to individual accounts, so that changes made to the details are made only once and automatically reflected in the linked accounts.

### BACKGROUND

It is generally known to provide access to an account by an individual. Of course, an individual having an account, such as a bank account, a brokerage account and the like, can easily obtain access to each individual account by requesting information from the proprietor of the account, such as a bank or brokerage house, by telephone, such as via an automatic telephone information retrieval system, or a computer, such as via an on-line service, whereby an individual may view the contents and important information of a particular account on a computer screen by accessing the account via the internet, or other computer network.

In addition, advisors or other entities, such as organizations, partnerships, companies and the like, typically also have access to an account of an individual or an organization. For example, an individual may telephone a broker and request information from the broker relating to a brokerage account. The broker typically has access to the individual's brokerage account via a computer so that the broker can access the individual's account and provide information to the individual. In addition, a broker can typically enter an individual's account and commit a task, such as buying or selling a stock, or changing information that may be contained within the account.

However, it is difficult for an advisor or some other entity to get a consolidated view of all accounts that an individual may have. For example, if an individual has a plurality of accounts at a bank, the advisor at the bank typically cannot access simultaneously all of the accounts of the bank and provide information relating to all of the accounts to the individual who may request the information. Moreover, an advisor may require information from all accounts to get a better picture of an individual's financial position, which may aid the advisor in making recommendations to the individual on particular decisions that may be made by the individual.

In addition, it is difficult for an organization to maintain a consolidated view of all accounts that the organization may be managing. For example, a bank may have a vast plurality of different types of accounts that may be associated with a corresponding vast plurality of individuals. A number of individuals may be invested in, for example, the same mutual fund. Being able to consolidate the views of each of these individuals who may have the same mutual fund may provide the bank with needed information so that the bank may make informed decisions relating to the mutual fund, or to the needs of the customers of the mutual fund.

The ability to obtain a consolidated view of multiple accounts may be useful for parent organizations that may be wish to monitor how a particular branch or subgroup is operating. For example, a bank may have branches spread out throughout a geographic area. Having consolidated access to a particular branch's accounts can allow the parent bank to obtain the necessary information relating to how successful the branch may be.

In addition, typical accounts have specific details that are associated with the particular accounts. For example, when setting up an account, specific information is typically necessary, such as a name or names, date of birth, social security number, address, and/or other like personal information. However, even though an individual may have multiple accounts associated with him or her, the specific details must be repeatedly entered into the subsequent accounts.

A need, therefore, exists for an improved system and method for obtaining consolidated views and access to individuals' or organizations' multiple accounts. Further, a need exists for an improved system and method for allowing an individual or organization to obtain access to all or many of the accounts owned by the individual or organization. Still further, a need exists for an improved system and method whereby an advisor, partnership, company and/or other organization has consolidated access to a number of accounts to easily obtain information necessary for the entity to make informed decisions, or to otherwise provide pertinent information to an individual or organization for the individual or organization to make informed decisions regarding the accounts. In addition, a need exists for a system and a method whereby all accounts of an individual or organization, even accounts that are not maintained by an advisor's system, may be provided for on one system and further can be accessed and reviewed by an individual, organization or advisor.

Moreover, a need exists for an improved system and method for providing “permissions” for individuals, organizations, advisors, and the like for accessing and acting on an account. In addition, a need exists for an improved system and method for allowing detailed information associated with an individual who owns multiple accounts to be changed once on all accounts, rather than in piecemeal fashion on each account.

### SUMMARY

Systems and methods of linking multiple entities to multiple accounts are provided in the particular embodiment of the present invention disclosed herein. Specifically, a customer database enables entities, such as individuals and/or organizations to be represented and linked to multiple accounts of different types and linked to each other. Associated with these links are “permissions” that enable or disable actions that can be performed on particular accounts by the accessing entity. Multiple entities can be linked to multiple accounts to support both retail and advisor-based relationships simultaneously. Additionally, details such as addresses, telephone numbers, and the like are linked to entities and not to individual accounts, so that changes made to the details are made only once and automatically reflected in the linked accounts.

Therefore, the systems and methods as described herein provide to an entity a plurality of accounts and account-types relating to various financial considerations, such as bank accounts, brokerage accounts, tax wrappers, and the like. In addition, the systems and methods provide linkages for the plurality of accounts such that the entity can have simultaneous and/or consolidated access to each account.

In addition, the systems and methods provide access to an individual's plurality of accounts by other entities. Moreover, the systems and methods provide these other entities with simultaneous access to the individual's plurality of accounts so that the other entity may provide complete analyses of the accounts and provide proper advice to the individual as to decisions that should be made relating to the plurality of accounts.

Still further, the systems and methods provide “permissions” to the various entities that have access to the plurality of accounts that may enable or disable actions that may be taken on an account or the plurality of accounts. In addition, the systems and methods allow detailed information, such as addresses, telephone numbers, and other like information of the entity to be associated with the entity so that a change in the detailed information can be reflected throughout all of the accounts owned by the entity. Moreover, information relating to an advisor, representative, or other like entity can further have detailed information that is associated with that entity, such that changes made only once to the detailed information of the advisor, representative, or other like entity can be reflected throughout all accounts linked with the advisor, representative, or other like entity.

Additional features and advantages of the present invention are described in, and will be apparent from, the detailed description of the presently preferred embodiments and from the drawings.

### BRIEF DESCRIPTION OF THE FIGURES

FIG. 1 illustrates a graphical representation of an entity having a plurality of accounts.

FIG. 2 illustrates a graphical representation of a plurality of entities, such as an advisor and a plurality of customers, wherein each of said plurality of customers has an account, wherein each of the plurality of accounts is linked to each respective customer and to the advisor.

FIG. 3 illustrates a graphical representation of a plurality of entities, such as an advisor and a plurality of customers, wherein said customers have a plurality of accounts, such as a plurality of trading accounts and/or a plurality of bank accounts, wherein each of said plurality of accounts is linked to the respective customer and to the advisor.

### DETAILED DESCRIPTION OF THE PRESENTLY PREFERRED EMBODIMENTS

Generally, methods of linking multiple entities to multiple accounts are provided. Specifically, a customer database enables entities, such as individuals and/or organizations to be represented and linked to multiple accounts of different types and linked to each other. Associated with these links are “permissions” that enable or disable actions that can be performed on particular accounts by the accessing entity. Multiple entities can be linked to multiple accounts to support both retail and advisor-based relationships simultaneously. Additionally, details such as addresses, telephone numbers, and the like are linked to entities and not to individual accounts, so that changes made to the details are made only once and automatically reflected in the linked accounts.

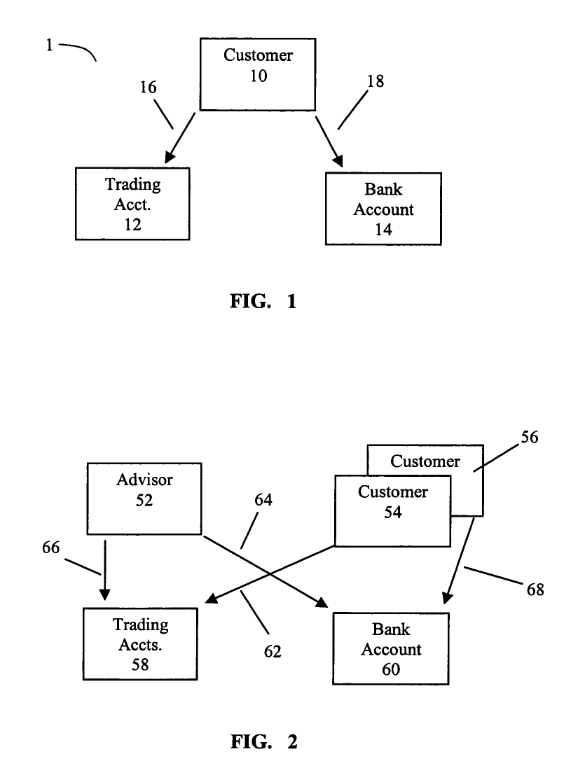

Now referring to FIG. 1, wherein like numerals refer to like parts, a system 1 is illustrated showing a customer 10 having a plurality of accounts 12, 14, such as a trading account and a bank account, for example. It should be noted, however, that any number and type of account may be owned by a customer, such as the aforementioned trading and bank accounts, but also including, but not limited to, tax wrappers, such as tax deferred investment accounts, such as 401K plans and the like. The plurality of accounts 12, 14 may be linked to the customer 10 via linkages 16, 18. Of course, other linkages may be provided if other accounts are present. In addition, any number of customers may be provided as well, whereby each customer has one or more accounts as described above. In addition, two or more customers may have joint accounts, which are shared by the two or more customers.

The customer 10 may be any entity able to own and make decisions about the particular accounts that the customer 10 may own. For example, the customer 10 may be an individual, a family, or any other type of organization, such as a business, not-for-profit organization, or the like. Moreover, as noted, any type of account may be owned by the customer 10 and linked to the customer 10.

The linkages 16, 18 provide the ability to access the plurality of accounts 12, 14 simultaneously so that all information relating to the plurality of accounts 12, 14 is available for decision-making or changing of the accounts. For example, access to the accounts may be provided via the Internet, such that the customer 10 may access a portal to a customer database (not shown) holding the information relating to the plurality of accounts. The portal may have a plurality of security features, such as passwords and the like, to ensure that only the customer or other appropriate entity or entities having permission can access the accounts. The portal provides the customer 10 with the ability to pull up windows showing the plurality of accounts simultaneously on the customer's computer screen, such that the customer may get a consolidated view and simultaneous access to each of the accounts. In addition, other customers may have access to their own accounts. Two or more customers owning a joint account may each have access to the joint account. An individual co-owner may restrict the other co-owners from access to any accounts solely owned by the individual co-owner.

FIG. 2 illustrates an alternate embodiment of the present invention, showing a system 50 having a plurality of entities, such as an advisor 52 and a plurality of customers 54, 56. Of course, any number of customers may be represented, and the present invention should not be limited as described above. Each of the plurality of customers 54, 56 has at least one account. For example, the customer 54 may own a trading account 58, while the customer 56 may own a bank account 60. The customer 54 is linked to the trading account 58 via a linkage 62, while the customer 56 is linked to the bank account 60 via the linkage 64. In addition, the advisor 52 is linked to both the trading account 58, owned by the customer 54, and the bank account 60, owned by the customer 56 via linkages 66, 68. Therefore, the advisor may have simultaneous access to the accounts, and may, therefore, be able to gather information relating to these separate accounts so that the advisor can give better advise to either customer 54 or 56. Although the consolidated and/or simultaneous access to all accounts is couched in terms of an “advisor”, it should be noted that other entities may have consolidated or simultaneous access to all accounts, such as customer service representatives or the like.

For example, the advisor 52 may have access to a portal whereby a database (not shown) stores the information relating to each customer's accounts. Of course, the portal may be protected by a plurality of security features as described above. The advisor 52 may, therefore, be able to pull up windows showing the various accounts 58, 60 simultaneously. Of course, if more customers, each having at least one account, are provided, the advisor 52 may have simultaneous access to these accounts as well.

There may be a plurality of “actions” that may be done to an account. These actions include: viewing the account, changing information in or otherwise updating the account, conducting trades, moving money from one account to another, or other like actions. Furthermore, different entities may have different types of “permissions” to conduct one or more of these actions. For example, an advisor may have permission to access, view, trade and move money in a managed account for a customer, but may only have access to view a bank account. Alternatively, the customer may only have access to view the managed account, but may conduct trades, update or move money into and out of his or her other accounts, such as his or her bank accounts. Of course, any other permutation may exist and is contemplated by the present invention. For example, the advisor 52 may only have access to a managed account, and a customer may restrict access to this or the other accounts by the advisor 52. Alternatively, an advisor may have the ability to view one or more accounts of a customer, but cannot attempt any other actions without permission from the customer. Of course, there may be no advisor, or other entity having such access to the customers accounts, as illustrated in FIG. 1.

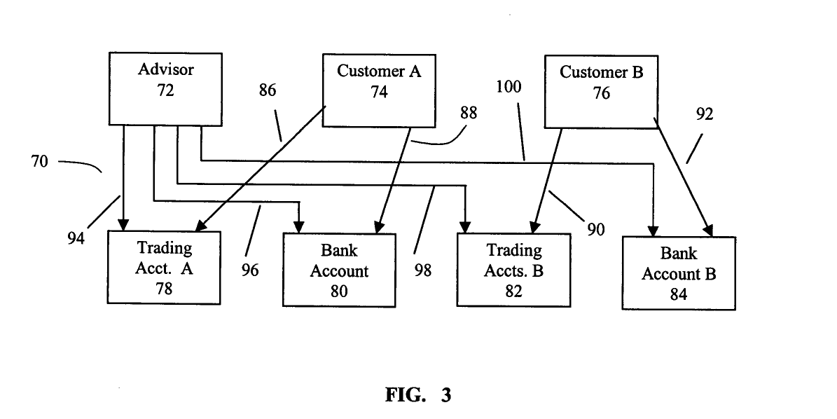

FIG. 3 illustrates a system 70 in an alternate embodiment of the present invention. The system 70 comprises an advisor 72 and a plurality of customers. Each of the customers may own a plurality of accounts. For example, as illustrated in FIG. 3, Customer A 74 may own a trading account A 78 and a bank account A 80, while Customer B 76 may own a trading account B 82 and a bank account B 84. Moreover, Customer A 74 may be linked to both the trading account A 78 and the bank account A 80 via linkages 86, 88, respectively, so that the plurality of accounts may be accessed simultaneously by the Customer A 74 via the internet or the like. In addition, Customer B 76 may be linked to both the trading account B 82 and the bank account B 84 via linkages 90, 92, respectively, so that the plurality of accounts may be accessed simultaneously by the Customer B 76 via the internet or the like. It should be noted that Customer A 74 does not have access to the accounts of Customer B 76, while Customer B 76 does not have access to the accounts of Customer A 74. However, should Customers A and/or B choose, they may allow access to and other actions to be performed on any of their accounts by another customer or by anyone else.

The advisor 72, however, can access all of the accounts, including the trading account A 78, the bank account A 80, the trading account B 82, and the bank account B 84 via linkages 94, 96, 98 and 100, respectively. Therefore, the advisor may have simultaneous access to all accounts of Customer A 74 and Customer B 76. Of course, Customers A and B may have any of a plurality of account types as noted above. In addition, any number of customers may be provided, and the advisor may have simultaneous access to the accounts of all of the customers.

An advisor may be further linked to other entities, such as other advisors or groups to form a company or a practice. These entities may further be linked to organizations and may represent branch or sub-practice structures. Consolidated and/or simultaneous views of all or any number of customers that an advisor may have access to may then be obtained by viewing the accounts from the various levels of the organizations. For example, a practice group may have simultaneous access to all of the accounts that are viewed by a plurality of advisors, while individual advisors may only have simultaneous access to the accounts that are assigned to the particular advisor. This allows managers and other decision-makers to monitor how accounts are performing across an entire practice group, or within a particular type of account. For example, a plurality of individuals may have a plurality of accounts in various managed mutual funds managed by a plurality of advisors. A practice group, or company, can obtain simultaneous access to view the plurality of accounts to compare the performances of the various mutual funds.

Further, accounts may or may not be directly held in the main database for access by the customers, advisors, and other entities as discussed above. For example, a particular customer may have a plurality of accounts within an organization, but may have an account in a separate bank that the customer wishes to maintain. A “shadow” account may be created within the database of the organization that mirrors the account from the separate bank, for example. The shadow accounts are utilized to provide a representation of the accounts that are held within the other systems. The shadow accounts may be fully linked and “permissioned” as detailed above with other accounts. In addition, the shadow accounts require the extra step of being updated periodically from the other system so that up-to-date information about this account is maintained.

In addition, by linking a plurality of customers to a particular advisor, whole accounts may easily be moved to other advisors if and when the particular advisor leaves the practice group.

Moreover, the specific details that may be related to a customer, an advisor, or to any other level of associated entities, may be associated directly with the customer, advisor, or other level of entity, and not to individual accounts per se, such that when information is changed or updated relating to these entities, the information need only be entered once into the database, while the linkages allow the information to be updated in all individual accounts simultaneously. For example, if an advisor manages 100 accounts and his or her address changes, it is necessary to alter the information only once in the database and the information is then updated in all linked accounts.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for accessing financial accounts comprising:
a first entity wherein said first entity owns two or more financial accounts wherein said first entity has simultaneous access to the two or more financial accounts;
a second entity, wherein said second entity further has simultaneous access to the two or more financial accounts; and
a database for storing information relating to the two or more financial accounts.

2. The system of claim 1 wherein the two or more financial accounts may be selected from the group consisting of bank accounts, brokerage accounts, and tax wrapper accounts.

3. The system of claim 1 wherein the access by the first entity and the second entity is via a computer.

4. The system of claim 1 wherein the access by the first entity and the second entity is via the Internet.

5. The system of claim 1 wherein said first entity has a first permission associated with said first entity wherein said first permission allows the first entity to conduct at least a first action on at least one of the two or more financial accounts.

6. The system of claim 1 wherein said second entity has a permission associated with said second entity wherein said permission allows the second entity to conduct at least a first action on at least one of the two or more financial accounts.

7. The system of claim 1 wherein said first entity has a first permission associated with said first entity wherein said first permission allows the first entity to conduct at least a first action on at least one of the two or more financial accounts and further wherein said second entity has a second permission associated with said second entity wherein said second permission allows the second entity to conduct a second action on at least one of the two or more financial accounts.

8. The system of claim 7 wherein said first action and said second action are different.

9. A system for accessing financial accounts comprising:
a first entity wherein said first entity owns at least a first financial account wherein said first entity has access to at least said first financial account;
a second entity wherein said second entity owns at least a second financial account wherein said second entity has access to at least said second financial account;
a third entity, wherein said third entity further has simultaneous access to at least said first and second financial accounts; and
a database for storing information relating to at least the first and second financial accounts.

10. The system of claim 9 wherein at least said first and second financial accounts are selected from the group consisting of bank accounts, brokerage accounts, and tax wrapper accounts.

11. The system of claim 9 wherein the access to at least said first and second financial accounts by said first, second or third entities is done via a computer network.

12. The system of claim 11 wherein said computer network is the Internet.

13. The system claim 9 wherein said first entity has a permission associated with said first entity wherein said permission allows the first entity to conduct at least a first action on at least the first financial account.

14. The system of claim 9 wherein said second entity has a permission associated with said second entity wherein said permission allows the second entity to conduct at least a first action on at least the second financial account.

15. The system of claim 9 wherein said third entity has a permission associated with said third entity wherein said permission allows the third entity to conduct at least a first action on said first financial account, said second financial account, or said third financial account.

16. A method of accessing stored financial accounts comprising the steps of:
providing a first entity wherein said first entity owns two or more financial accounts wherein said first entity has simultaneous access to the two or more financial accounts via a network;
accessing said two or more financial accounts simultaneously by said first entity via said network;
providing a second entity, wherein said second entity further has simultaneous access to the two or more financial accounts via the network;
accessing said two or more financial accounts simultaneously by said second entity via the network; and
storing said information relating to said two or more financial accounts in a database interconnected with said network.

17. The method of claim 15 wherein said network is a computer network.

18. The method of claim 15 further comprising the steps of:
providing a first permission to said first entity wherein said first permission allows the first entity to conduct at least a first action;
conducting the first action by said first entity wherein said first action is limited by said first permission;
providing a second permission to said second entity wherein said second permission allows the second entity to conduct a second action; and
conducting the second action by said second entity wherein said second action is limited by said second permission.

19. A method of accessing financial accounts comprising the steps of:
providing a first entity wherein said first entity owns at least a first financial account wherein said first entity has access to at least said first financial account via a network;
accessing at least said first financial account by said first entity via the network;
providing a second entity wherein said second entity owns at least a second financial account wherein said second entity has access to at least said second financial account via the network;
accessing at least said second financial account by said second entity via the network;
providing a third entity wherein said third entity further has simultaneous access to at least said first and second financial accounts via the network;
simultaneously accessing at least said first and second financial accounts by said third entity via the network; and
storing information relating to at least said first and second financial accounts in a database wherein said database is interconnected with said network.

20. The method of claim 20 wherein said network is a computer network.
